(19) United States
(12) Patent Application Publication
(10) Pub. No.: US 2012/0049680 A1
(43) Pub. Date: Mar. 1, 2012

(54) ROTATING DEVICE HAVING ROTOR, STATOR, AND DRIVING MECHANISM

(75) Inventor: Hiroshi SAITO, Shizuoka (JP)

(73) Assignee: ALPHANA TECHNOLOGY CO., LTD., Shizuoka (JP)

(21) Appl. No.: 13/223,180

(22) Filed: Aug. 31, 2011

(30) Foreign Application Priority Data
Sep. 1, 2010 (JP) 2010195601

(51) Int. Cl. H02K 7/08

(52) U.S. Cl. 310/90

(57) ABSTRACT

A rotating device includes: a rotor on which a recording disk is to be mounted; a stator rotatably supporting the rotor; and a driving mechanism configured to rotate the rotor with respect to the stator. The relationship between (a) the magnitude of a gap between the rotor and the stator and (b) a viscosity of a lubricant introduced in the gap is defined such that a Q-value of a peak of mechanical resonance in a translation mode of the rotating device is 3 or less when the peak of mechanical resonance and a peak of torque ripple in the driving mechanism are in the range of 1 kHz-5 kHz in a frequency spectrum.

### BACKGROUND OF THE INVENTION

1. Field of the Invention

The present invention relates to rotating devices having a rotor, a stator, and a driving mechanism.

2. Description of the Related Art

A hard disk drive is known as a medium used as a storage device in a computer. In a hard disk drive, a magnetic recording disk on which recording tracks are formed is rotated at high speed by a brushless motor. A magnetic head is placed against the surface of the magnetic recording disk with a slight distance in between for the purpose of reading/writing magnetic data contained in the recording tracks.

For example, Japanese Patent Application Publication No. 2007-213629 discloses an electric brushless motor used to rotate a recording disk in a recording disk driving device. The brushless motor comprises: a rotor having a rotor hub and a field magnet; a stator having an armature interacting with the field magnet to generate a torque and having a base to which the armature is fitted; and a bearing mechanism supporting the rotor so as to be rotatable with respect to the stator.

### SUMMARY OF THE INVENTION

A hard disk drive is configured to allow a magnetic recording disk to be rotated inside. Therefore, mechanical vibration caused by rotational driving occurs in the hard disk drive. Due to this mechanical vibration, hard disk drives make more or less noise.

Recently, hard disks are available in smaller sizes and with larger capacity and provide more user convenience. Due to increased convenience, hard disks are used in increasingly diverse situations. For example, hard disks are now often used in quiet environments such as living rooms. In such cases, it is necessary to reduce noise as much as possible in order to maintain quietude.

The requirement for reducing noise from a rotating device such as hard disk drives as much as possible exists not only in cases as described above but also in other situations.

The present invention addresses the above-described background and a purpose thereof is to provide a rotating device in which noise is reduced.

One embodiment of the present invention relates to a rotating device. The rotating device comprises: a rotor on which a recording disk is to be mounted; a stator rotatably supporting the rotor; and a driving mechanism configured to rotate the rotor with respect to the stator. The relationship between (a) the magnitude of a gap between the rotor and the stator and (b) a viscosity of a lubricant introduced in the gap is defined such that a Q-value of a peak of mechanical resonance in a translation mode of the rotating device is 3 or less when the peak of mechanical resonance and a peak of torque ripple in the driving mechanism are in the range of 1 (kHz)-5 (kHz) in a frequency spectrum.

The “rotating device” may be a device to drive a recording disk. For example, the rotating device may be a hard disk drive.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a top view of the rotating device according to the embodiment;

FIG. 2 is a view that is sectioned along the line A-A, as illustrated in FIG. 1;

FIG. 3 is a graph showing an example of frequency spectrum of mechanical resonance computed in the rotating device according to the comparative example, using computer simulation;

FIG. 4 is a graph showing computation of conditions that ensure a constant Q-value of the peak of resonance in the translation mode of the rotating device of FIG. 1, using computer simulation;

FIGS. 5A and 5B are graphs showing an example of frequency spectrum of mechanical resonance computed in the rotating device of FIG. 1, using computer simulation;

FIGS. 6A, 6B, and 6C illustrate the bearing of FIG. 2;

FIGS. 7A, 7B, 7C, and 7D show variations of the first circumferential contact part; and

FIGS. 8A and 8B illustrate a shaft according to a fifth variation.

### DETAILED DESCRIPTION OF THE INVENTION

The invention will now be described by reference to the preferred embodiments. Like numerals are used represent like elements and the description will be omitted as appropriate. The size of the component in each figure may be enlarged or reduced in scale in order to aid understanding. Some of the components in each figure may be omitted if they are not important for explanation. The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

The rotating device according to the embodiment is suitably used as a disk drive device (e.g., a hard disk drive) adapted to drive a magnetic recording disk mounted therein into rotation.

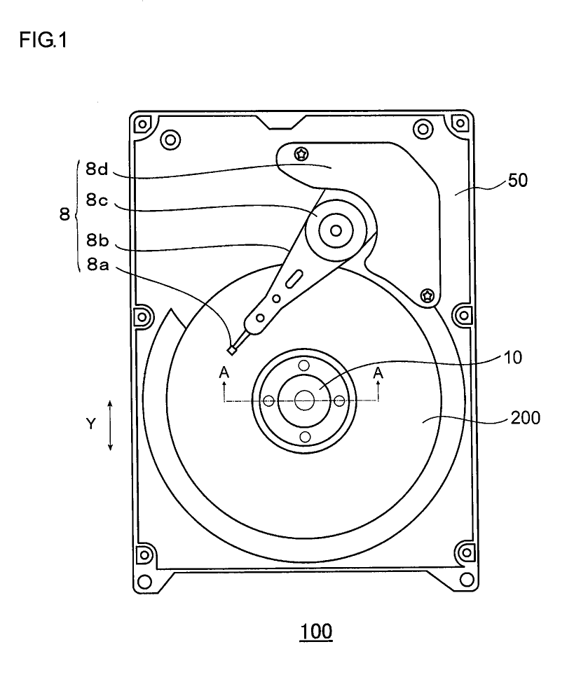

FIG. 1 is a top view of the rotating device 100 according to the first embodiment. In FIG. 1, the rotating device 100 is shown without a top cover in order to show the inside of the rotating device 100. The rotating device 100 comprises: a base plate 50; a hub 10; a magnetic recording disk 200; a data read/write unit 8; and the top cover.

Hereinafter, it is assumed that the side of the base plate 50 on which the hub 10 is installed (upside of the plane of paper in FIG. 1) is the “upper” side.

The magnetic recording disk 200 is mounted on the hub 10, and rotates with the hub 10. The base plate 50 is produced by die-casting an alloy of aluminum. The base plate 50 rotatably supports the hub 10 through a bearing unit to be described later. The data read/write unit 8 includes: a read/write head 8a; a swing arm 8b; a pivot assembly 8c; and a voice coil motor 8d. The read/write head 8a is attached to the tip of the swing arm 8b. The read/write head 8a records data onto and reads out data from the magnetic recording disk 200. The pivot assembly 8c swingably supports the swing arm 8b with respect to the base plate 50 around the head rotation axis. The voice coil motor 8d swings the swing arm 8b around the head rotation axis and moves the read/write head 8a to the desired position on the recording surface of the magnetic recording disk 200. The data read/write unit 8 is constructed using a known technique for controlling the position of the head.

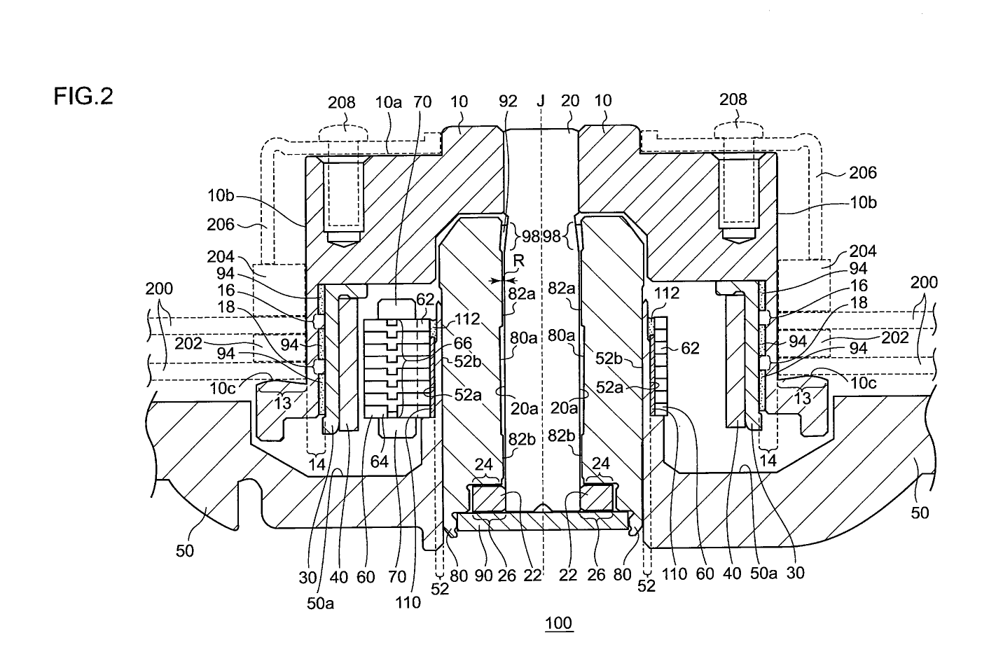

FIG. 2 is a view that is sectioned along the line A-A, as illustrated in FIG. 1. The rotating device 100 has and rotates two 3.5 inch-type magnetic recording disks 200 of 95 mm in diameter. Each of the two magnetic recording disks 200 of interest has a central hole of 25 mm in diameter. The thickness of each is 1.27 mm.

The rotating device 100 comprises a substantially cup-shaped hub 10, a shaft 20, a flange 22, a yoke 30, a cylindrical magnet 40, a base plate 50, a laminated core 60, coils 70, a sleeve 80, a plate 90, lubricant 92, glue 94, and a vibration-deadening ring 110.

The hub 10 is formed in a convex form of which the center is the rotational axis J of the motor. Hereinafter, it is assumed that the two magnetic recording disks 200 are mounted on the hub 10. An outer-cylindrical surface 10b of the convex portion of the hub 10 is fit into the central holes of the two magnetic recording disks 200. The lower one of the two magnetic recording disks 200 is seated on a seating surface 10c that extends radially from the lower end of the outer-cylindrical surface 10b. The diameter of the outer-cylindrical surface 10b is 25 mm. More precisely, the diameter of the outer-cylindrical surface 10b is 24.978±0.01 mm.

A ring-shaped first spacer 202 is inserted between the two magnetic recording disks 200. A clamper 206 presses the two magnetic recording disks 200 and the first spacer 202 against the hub 10 via a ring-shaped second spacer 204 in order to fix them together. The clamper 206 is affixed to the top surface 10a of the hub 10 by a plurality of clamping screws 208. The hub 10 has a cylindrical separating wall 14 that is sandwiched between the yoke 30 and two magnetic recording disks 200.

The yoke 30 has a reverse L-shaped cross section and is made of a magnetic material such as iron. The yoke 30 is affixed to an inner surface of the separating wall 14 using both adhesion and press-fitting. A first convex portion 16 and a second convex portion 18 are formed on the inner surface of the separating wall 14, and the yoke 30 is pressed against the two convex portions 16, 18 in the case where the yoke 30 is press-fit. Both the first convex portion 16 and the second convex portion 18 are formed in a ring shape around the rotational axis J of the motor. The two convex portions 16, 18 are separately formed along the axial direction so that the first convex portion 16 is formed on the upper side. Glue 94 is filled in between the inner surface of the separating wall 14 and an outer surface of the yoke 30. This is realized by applying a suitable amount of glue on the inner surface of the separating wall 14 before the yoke 30 is press-fit against the hub 10.

A protruding portion 13 for seating the lower one of the two magnetic recording disks 200 that protrudes upward is formed on the seating surface 10c of the hub 10. The protruding portion 13 is formed in a ring shape around the rotational axis J of the motor. A part of the protruding portion 13 on which the magnetic recording disk is seated is a smoothly-curved surface. The cross-section of the curved surface forms an arc. As a result, a portion where the magnetic recording disk 200 touches the seating surface 10c is substantially in a shape of a circle-line.

The cylindrical magnet 40 is glued on the inner surface of the yoke 30. The cylindrical magnet 40 is made of a rare-earth material such as Neodymium, Iron, or Boron. The cylindrical magnet 40 faces radially towards nine teeth of the laminated core 60. The cylindrical magnet 40 is magnetized for driving with eight poles along the circumferential direction. It is to be noted that the cylindrical magnet 40 is fixed to the hub 10 through the yoke 30.

One end of the shaft 20 is fixed in a hole located at the center of the hub 10 by using both a press-fit and glue. The flange 22 is press-fitted against the other end of the shaft 20. The shaft 20 is formed of a stainless SUS420J2 stainless steel to have an outer diameter of 4 mm in the neighborhood of the radial dynamic pressure groove.

A projecting portion 52, the center of which is along the rotational axis J of the motor, is formed on an upper surface 50a of the base plate 50. An outer surface of the projecting portion 52 is a cylindrical side surface 52a, the center of which is along the rotational axis J of the motor. The sleeve 80 is glued on an inner surface 52b of the projecting portion 52. The sleeve 80 accommodates the shaft 20. The plate 90 is glued onto a surface on the flange 22 side of the sleeve 80. An inner surface 80a of the sleeve 80 faces an outer surface 20a of the shaft 20. The sleeve 80 is formed by cutting a copper-based alloy material and plating the back surface thereof with electroless nickel afterwards.

The lubricant 92 is injected in a region in between a set of the shaft 20 and the flange 22 and a set of the sleeve 80 and the plate 90. The shaft 20, the flange 22, the lubricant 92, the sleeve 80, and the plate 90 constitute the bearing unit that rotatably supports the hub 10.

A pair of herringbone-shaped radial dynamic pressure grooves 82a and 82b that are vertically separated from each other are formed on the inner surface 80a of the sleeve 80. Hereinafter, the upper (toward the hub 10) radial dynamic pressure groove will be referred to as a first radial dynamic pressure groove 82a, and the lower (toward the base plate 50) radial dynamic pressure groove will be referred to as a second radial dynamic pressure groove 82b.

A first herringbone-shaped thrust dynamic pressure groove 24 is formed on the upper surface of the flange 22. A second herringbone-shaped thrust dynamic pressure groove 26 is formed on the lower surface of the flange 22. The hub 10 and the shaft 20 are axially and radially supported by the dynamic pressure generated in the lubricant 92 by these dynamic pressure grooves when the rotating device 100 rotates.

A capillary seal 98, where the gap between the inner surface of the sleeve 80 and the outer surface of the shaft 20 gradually increases upward, is formed on the opening side of the sleeve 80. The capillary seal 98 prevents the leakage of the lubricant 92 by way of the capillary effect.

The laminated core 60 has a ring portion 62 and nine teeth 64 that extend out radially from the ring portion 62. The laminated core 60 is formed by laminating eight nondirectional magnetic steel sheets, each of which has the thickness of 0.35 mm, and mechanically integrating them. In one of the methods for manufacturing this laminated core 60, a magnetic steel sheet, the surface of which is insulated, is pressed. Individual magnetic steel sheets are formed by punching the sheet to produce a desired core shape, while also creating half punches. Second, eight core-shaped magnetic steel sheets are mechanically integrated by caulking the sheets in a mold using the above-mentioned half-punch. After this integration, the surface of the laminated core is treated, for example, in order to prevent the abrasion of the surface of the laminated core. Many methods can be used for this surface treatment. For example, a method in which an epoxy resin is applied by a spray coating or a method using a cation electrodeposition coating is advantageous in that the thickness of the film can be made uniform. The epoxy resin is applied so that its thickness is about 70 μm. Therefore, in the present embodiment, the thickness T1 of the laminated core 60 is about 2.94 mm.

Each of the coils 70 is wound around one of the nine teeth 64, respectively. A driving flux is generated along the tooth 64 by applying a three-phase substantially sinusoidal driving current through the coils 70.

The vibration-deadening ring 110 is a tubular part that is made of material softer than the magnetic steel sheet of the laminated core 60. Aluminum, which is light and easily worked, is one example of such material. The vibration-deadening ring 110 is located in between the laminated core 60 and the projecting portion 52. The vibration-deadening ring 110 further fastens, in the axial direction, each magnetic steel sheet of the laminated core 60 by being press-fitted into the ring portion 62 of the laminated core 60.

The laminated core 60, with the vibration-deadening ring 110 pre-fitted, is engaged with the projecting portion 52 so that the lower surface 60a of the laminated core 60 meets the seat 54 which extends radially from the lower end of the cylindrical side surface 52a and is fixed therein. The means for the fixing is, for example, gluing or press-fitting. In this case, it is less likely to generate contaminants such as particles.

In order to more strongly affix the laminated core 60 to the base plate 50, in addition to the fixation using the vibration-deadening ring 110, vibration-deadening glue 112 is introduced in the region between the inner surface 62a of the ring portion 62 and the side surface 52a of the projecting portion 52 where the vibration-deadening ring 110 is not present. In particular, the vibration-deadening glue 112 is introduced so that the region is filled with the vibration-deadening glue 112. This would reduce the possibility of the laminated core 60 leaning with respect to the projecting portion 52. As a result, it is possible to maintain the uniformity of the gap between the tooth 64 and the cylindrical magnet 40.

Several kinds of glue can be adopted as the vibration-deadening glue 112. For example, thermosetting epoxy-resin glue is preferable in that stable adhesion strength can be obtained.

In this embodiment, at least the hub 10, the shaft 20, the flange 22, the yoke 30, and the cylindrical magnet 40 constitute a rotor on which the magnetic recording disk 200 is mounted. At least the base plate 50, the laminated core 60, the coil 70, the sleeve 80, the plate 90, and the vibration-deadening ring 110 constitute a stator rotatably supporting the rotor. At least the cylindrical magnet 40, the laminated core 60, and the coil 70 constitute a driving mechanism that rotates the rotor with respect to the stator.

Generally, given that the revolution is N Hz and the number of magnetic poles is P, the torque of a three-phase brushless motor includes torque ripple having a frequency given by 3PN Hz. In the case of the rotating device 100 according to the embodiment, the number of magnetic poles P is such that P=8 and a three-phase substantially sinusoidal driving current flows in the coil 70. Therefore, given that the revolution N is such that N=98.3 Hz (5900 rpm), the torque generated by the driving mechanism includes torque ripple having a central frequency f_{c}=3PN≅2359 Hz. In other words, a driving mechanism like this produces torque ripple frequency components in a range 1 kHz-5 kHz, which belongs to the audible frequency range and which is particularly likely to be experienced as noise by human beings.

The central frequency f_{c} of torque ripple represents a central frequency of a peak of torque ripple (i.e., a peak corresponding to torque ripple) in a frequency spectrum of the torque generated by the driving mechanism, 3PN Hz being a theoretical value.

In order to obtain findings about noise from a rotating device, we manufactured a rotating device according to a comparative example in which the gap R between the shaft and the sleeve is such that R=3 μm in the neighborhood of the radial dynamic pressure groove and in which a lubricant with a kinetic viscosity ν of 12 cSt at 40° C. fills the gap. The conditions other than the magnitude R of the gap and the kinetic viscosity ν of the lubricant in the rotating device according to the comparative example are defined to be identical to those of the rotating device 100 according to the embodiment. The rotating device according to the comparative example is rotated at the revolution N=98.3 Hz (5900 rpm) to collect noise and obtain a frequency spectrum of the noise. The resultant frequency spectrum indicated that frequency components in the range 1 kHz-5 kHz are comparatively larger in magnitude than the other components. The central frequency f_{c} of torque ripple in the rotating device according to the comparative example is such that f_{c}=3PN≅2359 Hz. In other words, the resultant frequency spectrum of noise indicated that frequency components around the central frequency f, of torque ripple are comparatively larger in magnitude. We found out from these findings that torque ripple is likely to be one of the causes of noise from a rotating device.

We then conducted computer simulation of mechanical resonance in a translation mode of the rotating device according to the comparative example in order to delve into the mechanism whereby torque ripple causes noise.

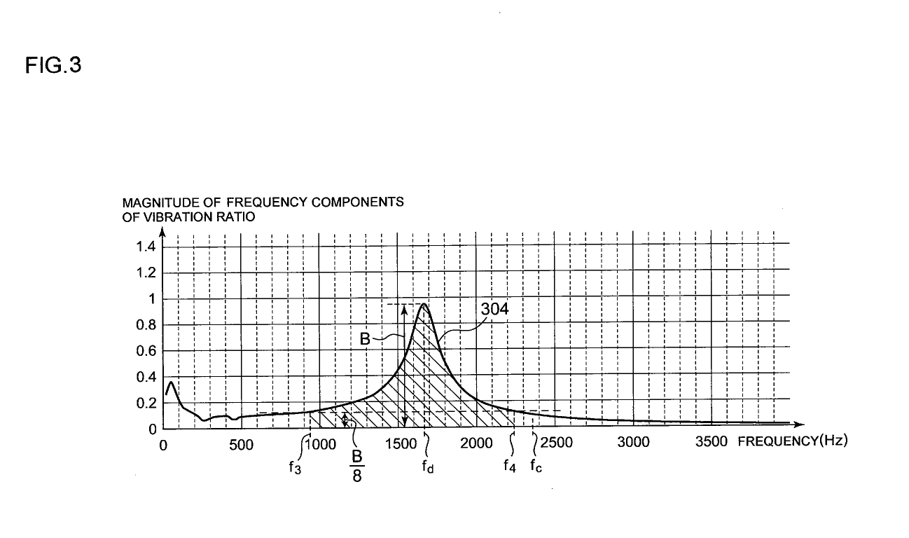

FIG. 3 is a graph showing an example of frequency spectrum of mechanical resonance computed in the rotating device according to the comparative example, using computer simulation. In this computer simulation, the ratio between the magnitude of vibration exerted to the base plate in the longitudinal direction with respect to the magnitude of vibration of the magnetic recording disk (hereinafter, referred to as vibration ratio) is used as a parameter indicating the magnitude of mechanical resonance of the rotating device. The larger the vibration ratio, the larger the vibration of magnetic recording disk with respect to the vibration exerted, i.e., the larger the mechanical resonance. The horizontal axis of FIG. 3 represents a frequency measured in Hz, and the vertical axis represents the magnitude of the frequency component of the vibration ratio measured in a desired unit.

The shaded zone in FIG. 3 indicates a peak 304 corresponding to the mechanical resonance of the rotating device according to the comparative example. The central frequency f_{d} of the peak 304 of the mechanical resonance is defined as a frequency at which the frequency component of the vibration ratio is at maximum in the frequency range defining the peak 304. In the example of FIG. 3, the central frequency f_{d} is located at approximately 1660 Hz. The frequency component of the vibration ratio at the central frequency f_{d} will be denoted by B.

The frequency at which the frequency component of the vibration ratio drops to B/8 for the first time in a frequency range lower than the central frequency f_{d} will be referred to as a third frequency f₃, and the frequency at which the frequency component of the vibration ratio drops to B/8 in a higher frequency range will be referred to as a fourth frequency f₄. In this embodiment, the frequency range defining the peak 304 of the mechanical resonance is defined between the third frequency f₃ and the fourth frequency f₄, both inclusive.

FIG. 3 shows that the peak 304 of the mechanical resonance (resonance point) is located in the neighborhood of the central frequency f_{c} (≅2359 Hz). The figure also shows that the peak 304 is located in the range 1 kHz-5 kHz which belongs to an audio frequency range and which is particularly likely to be experienced as noise by human beings. The Q-value of the peak 304 of resonance is determined to be about 6.

The Q-value is given by

$$Q = \frac{{f}_{d}}{{f}_{6} - {f}_{5}} = \frac{{f}_{d}}{F W H M}$$

where f5 (fifth frequency) denotes a frequency at which the frequency component of the vibration ratio drops to B/2 (i.e., half the frequency component of the vibration ratio at the central frequency f_{d}) for the first time in a frequency range lower than the central frequency f_{d}, and f6 (sixth frequency) denotes a frequency at which the frequency component of the vibration ratio drops to B/2 for the first time in a frequency range higher than the central frequency f_{d}. Generally, the higher the Q-value, the longer the vibration lasts once it is started. The lower the Q-value, the sooner the vibration is attenuated.

In the rotating device according to the comparative example, the peak 304 of the mechanical resonance with a relatively high Q-value is located in the range 1 kHz-5 kHz which belongs to an audio frequency range and which is particularly likely to be experienced as noise by human beings. Further, the central frequency f_{c} of torque ripple is located in the neighborhood of the peak 304. Therefore, it is considered that the torque ripple included in the torque generated by the driving mechanism excites the rotating device according to the comparative example. The mechanical resonance enhances the vibration, causing, in particular, the magnetic recording disk to be vibrated seriously. The central frequency f_{d} of the vibration enhanced by the mechanical resonance is approximately 1660 Hz and is in the range 1 kHz-5 kHz which belongs to an audio frequency range and which is particularly likely to be experienced as noise by human beings. Therefore, the large vibration in the audible range is considered to induce noise in the rotating device according to the comparative example.

A discussion will be now given on the vibration of the rotating device according to the comparative example in the peak 304 of the mechanical resonance and on the Q-value of the peak 304. A computer simulation of the behavior of vibration of the rotating device according to the comparative example in the neighborhood of the peak 304 of the mechanical resonance reveals that the base plate and the hub are alternately displaced in opposite phases in the longitudinal direction of the base plate (in the Y-direction of FIG. 1). In other words, the peak 304 of the mechanical resonance is the peak of resonance in the translation mode.

In the rotating device according to the comparative example, the vibration generated in the laminated core 60 due to the torque ripple represents the source of excitation. It is considered that resonance in the translation mode is generated as a result of the kinetic energy applied by excitation traveling, via the bearing, between the base plate and the hub on which the magnetic recording disk is mounted. This is a mechanism whereby the torque ripple induces noise.

This shows that, in order to reduce resonance in the translation mode and reduce noise accordingly, the requirement is to increase the loss incurred during transmission of the kinetic energy in the bearing. It should be noted that the smaller the loss incurred during transmission of the kinetic energy in the bearing, the higher the Q-value. The larger the loss incurred during transmission, the lower the Q-value. Therefore, noise in the rotating device caused by vibration due to the torque ripple will be successfully suppressed by reducing the Q-value.

One alternative approach would be to move the central frequency of resonance in the translation mode out of the range 1 kHz-5 kHz which belongs to an audio frequency range and which is particularly likely to be experienced as noise by human beings. Where restriction is imposed on the specification (e.g., shape) of the rotating device, it is difficult to substantively displace the central frequency of resonance in the translation mode by devising a structure of the rotating device.

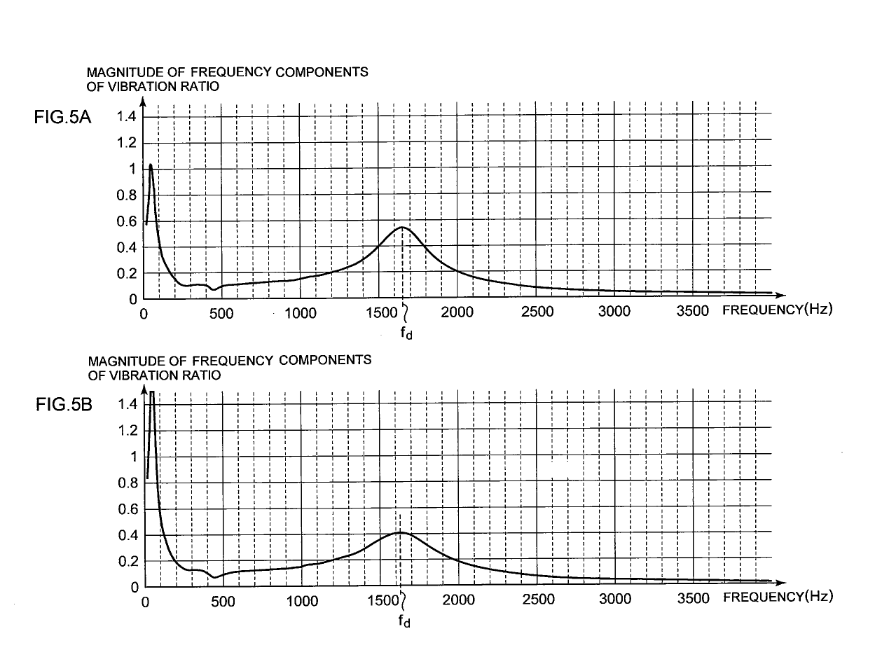

As understood from FIGS. 3 and from 5A and 5B (described later), the impact from suppressing the Q-value (in FIG. 3, Q≅6 and, in FIG. 5A, Q≅3) is confirmed to be higher than the impact from displacing the central frequency (in FIG. 3, f_{d}=1660 Hz and, in FIG. 5A, f_{d}=1650 Hz). Therefore, an approach of suppressing the Q-value as in the embodiment would be more effective.

A discussion will now be given on the loss incurred during transmission of the kinetic energy in the bearing. In the bearing, the inner surface of the sleeve is opposite to the outer surface of the shaft via a lubricant. Our computation shows that the loss incurred in transmission of the kinetic energy becomes larger and the Q-value becomes lower, by enlarging the gap or by lowering the absolute viscosity η of the lubricant.

One qualitative understanding of the findings obtained by computation is as follows. When the gap between the sleeve and the shaft is zero, i.e., when the sleeve and the shaft are in contact, the sleeve and the shaft are vibrated as one piece so that the little loss is incurred during transmission of the kinetic energy. If the gap is sufficiently larger than the amplitude of the vibration, vibration in either the sleeve or the shaft is hardly transmitted to the other so that the loss incurred during transmission of the kinetic energy is very large. Further, the relationship between the magnitude of the gap and the loss incurred during transmission of the kinetic energy is considered to vary monotonously between the two extremes described above. It is therefore considered that the larger the gap, the larger the loss incurred during transmission of the kinetic energy.

Similarly, if the absolute viscosity η of the lubricant is extremely high, the sleeve and the shaft are vibrated as one piece so that the little loss is incurred during transmission of the kinetic energy. If the absolute viscosity η of the lubricant is extremely low (e.g., the absolute viscosity of air), vibration in either the sleeve or the shaft is hardly transmitted to the other so that the loss incurred during transmission of the kinetic energy is extremely large. Further, the relationship between the absolute viscosity η of the lubricant and the loss incurred during transmission of the kinetic energy is considered to vary monotonously between the two extremes described above. It is therefore considered that the lower the absolute viscosity η of the lubricant, the larger the loss incurred during transmission of the kinetic energy.

Based on the above observation, the relationship between (a) the magnitude of the gap between the rotor and the stator and (b) the viscosity of the lubricant 92 introduced in the gap is defined in the rotating device 100 according to the embodiment so that the Q-value of the peak of resonance is 3, which is half that of the comparative example, or less when the peak of resonance in the translation mode of the rotating device 100 is in the range 1 kHz-5 kHz in the frequency spectrum. According to this, the Q-value of the peak of resonance in the translation mode drops to 3 or less so that the larger loss is incurred during transmission of the kinetic energy in the bearing accordingly, with the result that noise caused by the torque ripple is effectively reduced.

In this embodiment, the magnitude R of the gap between the shaft 20 and the sleeve 80 in the neighborhood of the radial dynamic pressure groove is employed as a measure of the magnitude of the gap between the rotor and the stator, as in the case of the rotating device according to the comparative example. In an alternative example, a reference value such as an average value obtained by averaging the magnitude of the gap between the shaft 20 and the sleeve 80 in the direction of the motor rotation axis J may be used. Still alternatively, the reference value may be the maximum value or minimum value of the magnitude of the gap.

It should also be noted that the Q-value of the peak of resonance in the translation mode of the rotating device 100 may become high due to variance in production or due to time-dependent variation. In association with this, the relationship between (a) the magnitude of the gap R between the shaft 20 and the sleeve 80 in the neighborhood of the radial dynamic pressure groove and (b) the viscosity of the lubricant 92 introduced in the gap may be defined so that the Q-value of the peak of resonance is 2 or less when the peak of resonance in the translation mode of the rotating device 100 is in the range 1 kHz-5 kHz in the frequency spectrum. In this way, variation in the Q-value due to, for example, time-dependent variation can be addressed.

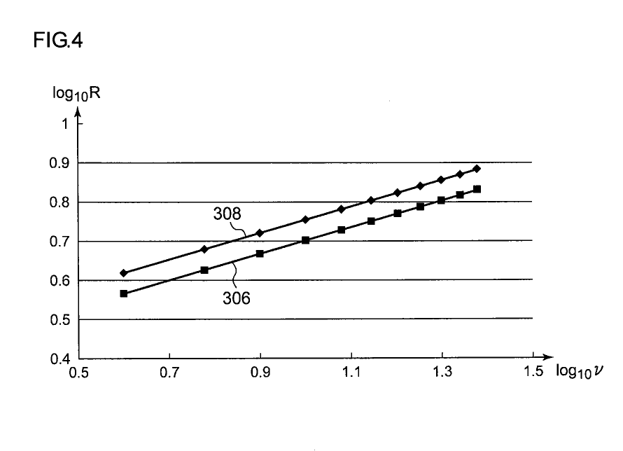

FIG. 4 is a graph showing computation of conditions that ensure a constant Q-value of the peak of resonance in the translation mode of the rotating device 100, using computer simulation. FIG. 4 shows plots of parameter values that ensure Q=constant determined by computer simulation, where it is given that the range of kinetic viscosity r of the lubricant 92 at 40° C. is 4 cSt-24 cSt, and the range of magnitude R of the gap between the shaft 20 and the sleeve 80 in the neighborhood of the radial dynamic pressure groove is 3 μm-8 μm. FIG. 4 is a double logarithmic chart, where the horizontal axis represents kinetic viscosity ν cSt in the common logarithmic scale, and the vertical axis represents the magnitude R μm of the gap between the shaft 20 and the sleeve 80 in the neighborhood of the radial dynamic pressure groove in the common logarithmic scale.

A regression line 306 is obtained by approximating data points (shown in FIG. 4 as square dots) corresponding to Q=3, using an approximation method such as the least-square method. The regression line 308 is obtained by approximating data points (shown in FIG. 4 as rhombic points) corresponding to Q=2, using an approximation method such as the least-square method.

The density of the lubricant 92 at 40° C. is about 1 g/cm³. The regression line 306 corresponding to Q=3 indicates that the following relationship holds when Q=3 between the absolute viscosity η P of the lubricant 92 at 40° C. and the magnitude R μm of the gap between the shaft 20 and the sleeve 80.

R=k(η)^{0.34}

where k is a variable that determines the Q-value and that does not depend on the absolute viscosity η or the magnitude R of the gap. The variable k is determined by the mechanical strength of the material of the base plate 50 and the diameter of the shaft 20. The variable k can be determined experimentally. The variable k and the Q-value are related such that the larger the Q-value, the smaller the variable k.

The range in the graph of FIG. 4 where the Q-value is 3 or less includes the regression line 306 corresponding to Q=3 and a range above the line. In other words, when the magnitude R μm of the gap between the shaft 20 and the sleeve 80 in the neighborhood of the radial dynamic groove satisfies the following expression in relation to the absolute viscosity η P of the lubricant 92 at 40° C., the Q-value is 3 or less.

R≧k(η)^{0.34}

Given that the base plate 50 is formed of an alloy of aluminum and the diameter of the shaft 20 is 4 mm, k=10.8 is obtained as a threshold value that ensures that the Q-value is 3 or less in the rotating device 100 according to the embodiment. In other words, when the magnitude R μm of the gap between the shaft 20 and the sleeve 80 in the neighborhood of the radial dynamic groove satisfies the following expression in relation to the absolute viscosity η P of the lubricant 92 at 40° C., the Q-value is 3 or less.

R≧10.8(η)^{0.34}

In a similar condition, k=12. 3 is obtained as a threshold value that ensures that the Q-value is 2 or less. In other words, when the magnitude R μm of the gap between the shaft 20 and the sleeve 80 in the neighborhood of the radial dynamic groove satisfies the following expression in relation to the absolute viscosity η P of the lubricant 92 at 40° C., the Q-value is 2 or less.

R≧12.3(η)^{0.34}

FIGS. 5A and 5B are graphs showing an example of frequency spectrum of mechanical resonance computed in the rotating device 100, using computer simulation. The horizontal axis of FIGS. 5A and 5B represents a frequency measured in Hz, and the vertical axis represents the magnitude of the frequency component of the vibration ratio measured in a desired unit.

FIG. 5A shows a frequency spectrum of resonance in the rotating device 100 when the kinetic viscosity ν=12 cSt and the magnitude R of the gap is such that R=5.3 μm. FIG. 5A indicates that the central frequency f_{d} of the peak of resonance in the translation mode of the rotating device 100 is about 1650 Hz. The Q-value of the peak, in the frequency spectrum, of resonance in the translation mode of the rotating device 100 is determined to be about 3.

FIG. 5B shows a frequency spectrum of resonance in the rotating device 100 when the kinetic viscosity ν=12 cSt and the magnitude R of the gap is such that R=6.0 μm. FIG. 5B indicates that the central frequency f_{d} of the peak of resonance in the translation mode of the rotating device 100 is about 1640 Hz. The Q-value of the peak, in the frequency spectrum, of resonance in the translation mode of the rotating device 100 is determined to be about 2.

For the rotating device 100 according to the embodiment configured such that Q=3, we rotated the device 100 at the revolution N=98.3 Hz (5900 rpm) and monitored the noise. We confirmed that the level of noise having frequency components in the range 1 kHz-5 kHz is reduced in comparison with that of the comparative example.

In the rotating device 100 according to the embodiment, the gap between the rotor and the stator is enlarged based on the above-described relationship for the purpose of reducing noise. By enlarging the gap, the rigidity of the bearing in the radial direction is generally reduced. In other words, reduction of noise is achieved in the embodiment at the cost of reduced rigidity in the radial direction. This means that there will be more chances that the shaft 20 and the sleeve 80 come into contact with each other while the rotating device 100 is in rotation. In an awareness of the fact that the shaft 20 and the sleeve 80 come into contact during rotation, we devised a structure of the bearing adapted to the situation.

Depending on the environment in which the rotating device 100 is used, the device may undergo a gyro moment during rotation. If the rigidity of the bearing in the radial direction is low, the shaft 20 receiving the gyro moment is more likely to come into contact with the sleeve 80. The less frequent the shaft 20 and the sleeve 80 come into contact with each other, the better. Therefore, the magnitude R of the gap between the shaft 20 and the sleeve 80 in the neighborhood of the radial dynamic pressure groove may be 7 μm or less in order to reduce the likelihood of contact.

In addition, the magnitude R of the gap may be 5 μm or more in order to reduce the mechanical resonance.

Generally, when a rotating device is mounted for use in a mobile device such as a cell phone, the device may undergo strong impact during rotation because of a fall, for example. If the gyro moment due to the strong impact is larger than the rigidity of the bearing in the radial direction, the shaft may come into contact with the sleeve. If the portion of the inner surface of the sleeve where the radial dynamic pressure groove is formed comes into contact with the shaft, the radial dynamic pressure groove may be damaged. If the radial dynamic pressure groove is damaged, the radial dynamic pressure in the damaged portion is reduced with the result that the overall distribution of dynamic pressure may be disturbed. If the overall distribution of dynamic pressure is disturbed, the rotation accuracy of the hub is disturbed and, in the worst scenario, the bearing could be burnt out.

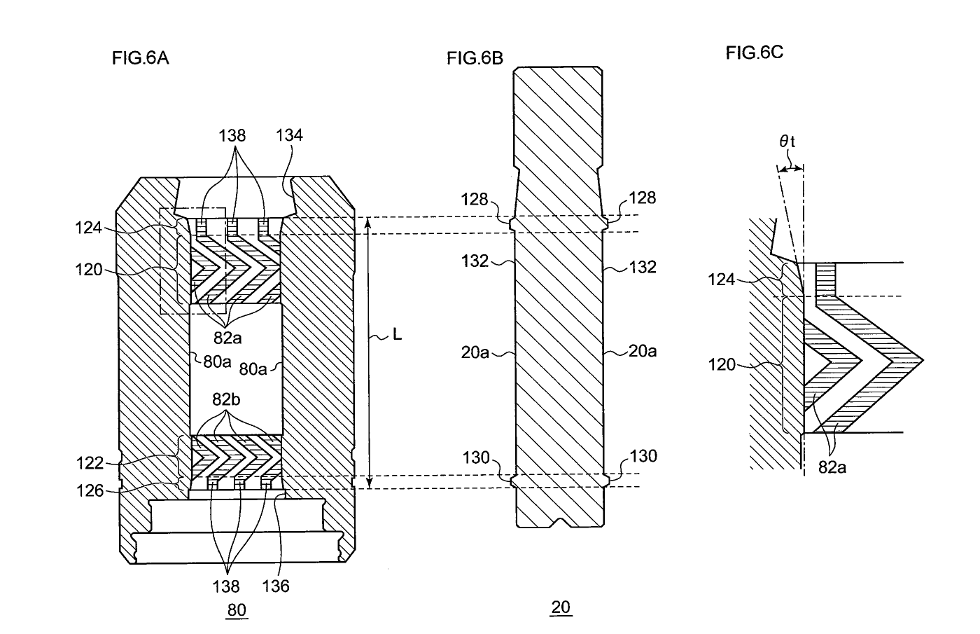

FIGS. 6A, 6B, and 6C illustrate the bearing of FIG. 2. FIG. 6A is a transparent section of the sleeve 80. FIG. 6B is a section of the shaft 20. FIG. 6C is an enlarged view of an area in FIG. 6A encircled by a dashed line. Referring to FIGS. 6A and 6B, the position, in the direction of the motor rotational axis J, of the shaft 20 of FIG. 6B with respect to the sleeve 80 of FIG. 6A is the same as that of the shaft 20 of FIG. 2, which shows the shaft 20 accommodated in the sleeve 80. The broken lines connecting FIGS. 6A and 6B indicate that the positions in the direction of the motor rotational axis J are aligned.

The inner surface 80a of the sleeve 80 is formed with a first dynamic pressure generation part 120 provided with a first radial dynamic pressure groove 82a, a first circumferential contact part 124 provided to extend from the first dynamic pressure generation part 120 toward the hub 10, a second dynamic pressure generation part 122 provided with a second radial dynamic pressure groove 82b, and a second circumferential contact part 126 provided to extend from the second dynamic pressure generation part 122 toward the base plate 50. In the transparent section of FIG. 6A, the radial dynamic pressure groove formed in the curved inner surface 80a is illustrated in a simplified fashion to facilitate the description.

In case the shaft 20 is inclined with respect to the motor rotational axis J, as it goes farther away from the central position of the sleeve 80 in the direction of the motor rotational axis J toward the hub 10 or toward the base plate 50, the gap (the minimum value thereof in the circumferential direction) between the shaft 20 and the sleeve 80 becomes smaller. Therefore, in case the shaft 20 is inclined with respect to the motor rotational axis J so that the shaft 20 comes into contact with the inner surface 80a of the sleeve 80, at least one of the first circumferential contact part 124 and the second circumferential contact part 126 comes into contact with the shaft 20 prior to the dynamic pressure generation parts 120 and 122. When at least one of the first circumferential contact part 124 and the second circumferential contact part 126 comes into contact with the shaft 20, the shaft 20 is prevented from being further inclined so that the contact between the radial dynamic pressure groove and the shaft 20 is prevented and the non-contact state of the dynamic pressure generation parts 120 and 122 and the shaft 20 is maintained.

If the magnitude R of the gap between the shaft 20 and the sleeve 80 in the neighborhood of the radial dynamic pressure grooves 82a and 82b is large, the angle of inclination θs of the shaft 20 with respect to the motor rotational axis J occurring when the shaft 20 is contact with the circumferential contact parts 124 and 126 becomes large. If the circumferential contact part is formed in a cylindrical shape not tapered, the area of contact between the shaft 20 and the circumferential contact part becomes smaller according to the angle of inclination θs, with the result that the surface pressure there is high. As a result, abrasion of the shaft 20 or the circumferential contact part may be promoted so that reliability may be reduced.

Referring to FIGS. 6A and 6C, the dynamic pressure generation parts 120 and 122 are formed in a cylindrical shape not tapered. The first circumferential contact part 124 is formed in a tapered shape with a taper angle θt such that the radius is progressively larger toward the hub 10 from the end of the first dynamic pressure generation part 120 toward the hub 10. The second circumferential contact part 126 is formed in a tapered shape such that the radius is progressively larger toward the base plate 50 from the end of the second dynamic pressure generation part 122 toward the base plate 50.

This increases an area of contact between the circumferential contact parts 124, 126 and the shaft 20, with the result that the surface pressure there is reduced. Therefore, abrasion of the shaft 20 or the circumferential contact parts 124 and 126 is reduced even when the angle of inclination θs is large, with the result that the reliability is improved.

The taper angle θt of the first circumferential contact part 124 will be discussed. Given that the minimum gap between the circumferential contact part and an opposite part facing the circumferential contact part is denoted by r, and the distance between the upper end of the first circumferential contact part 124 and the lower end of the second circumferential contact part 126 is denoted by L, the maximum value θmax of the angle of inclination θs of the shaft 20 will be given by the following expression.

$${θ}_{max} = arctan ( \frac{2 r}{L} )$$

When the shaft 20 comes into contact with the first circumferential contact part 124, in order to make the contact surfaces of the both parallel to each other as much as possible, it will be necessary to ensure that the taper angle θt of the first circumferential contact part 124 is equal to the maximum value θmax of the angle of inclination θs of the shaft 20. Therefore, the first circumferential contact part 124 may be formed such that the taper angle θt satisfies the following expression.

$$0 < {θ}_{t} \leq arctan ( \frac{2 r}{L} )$$

For example, if it is given that L=12 mm and r=7 θmax=0.067°. so that the taper angle θt of the first circumferential contact part 124 may have a slightly smaller value of 0.05°. This is advantageous in that abrasion is further mitigated.

A similar discussion holds true of the taper angle of the second circumferential contact part 126.

FIGS. 6A and 6C show the taper angle larger than it actually is for ease of understanding.

Referring to FIG. 6B, the outer surface 20a of the shaft 20 is formed with a first opposite part 128 in a cylindrical shape facing the first circumferential contact part 124, a cylindrical opposite part 132 facing both the first dynamic pressure generation part 120 and the second dynamic pressure generation part 122, and a second opposite part 130 in a cylindrical shape facing the second circumferential contact part 126. The diameter of the first opposite part 128 and the diameter of the second opposite part 130 are larger than the diameter of the cylindrical opposite part 132 by 2 μm.

FIG. 6B shows the difference in the diameter larger than it actually is for ease of understanding.

This further ensures that, when the shaft 20 is inclined, the circumferential contact parts 124 and 126 come into contact with the opposite parts 128 and 130 of the shaft prior to the dynamic pressure generation parts 120 and 122.

If the width of the circumferential contact parts 124 and 126 in the direction of the motor rotational axis J is too large, the axial span of the pair of dynamic pressure generation parts 120 and 122 is reduced accordingly, resulting in reduced rotation accuracy of the shaft 20. If the width is too small, the likelihood of the shaft 20 coming into contact with the dynamic pressure generation parts 120 and 122 is increased. The first circumferential contact part 124 may be formed such that the width thereof in the direction of the motor rotational axis J is in a range between 1/10 and ⅓ the width of the first dynamic pressure generation part 120 in the direction of the motor rotational axis J. A similar discussion holds true of the second circumferential contact part 126. In this case, the likelihood of the shaft 20 coming into contact with the dynamic pressure generation parts 120 and 122 is maintained at a level that presents no practical problems, while also preventing reduction in the rotation accuracy of the shaft 20.

For example, the first circumferential contact part 124 may be formed such that the width thereof in the direction of the motor rotational axis J is 2 mm or less. This suitably reduces reduction of the rotation accuracy of the shaft 20. Alternatively, the first circumferential contact part 124 may be formed such that the width thereof in the direction of the motor rotational axis J is 0.5 mm or more, and, more preferably, 1 mm or more. This can maintain the likelihood of the shaft 20 coming into contact with the dynamic pressure generation parts 120 and 122 at a level that presents no practical problems. A similar discussion holds true of the second circumferential contact part 126.

A circumferential contact part may be provided for only one of the pair of dynamic pressure generation parts. However, the radial dynamic pressure groove for which a circumferential contact part is not provided may not be sufficiently protected in this way. Meanwhile, the rotating device 100 according to the embodiment is configured such that circumferential contact parts are provided for both dynamic pressure generation parts 120 and 122. This is advantageous in that both radial dynamic pressure grooves are protected.

Contact of the shaft 20 with the circumferential contact parts 124 and 126 may produce shavings. When the shavings are transported to the dynamic pressure generation parts 120 and 122 and collected therein, abrasion of the radial dynamic pressure grooves 82a and 82b may be promoted. If the surface roughness of the circumferential contact part is high, contact resistance occurring when the shaft comes into contact with the circumferential contact part will be high accordingly, with the result that the likelihood of producing shaving is increased. To address this, the rotating device 100 according to the embodiment is configured such that the surface roughness of the circumferential contact parts 124 and 126 is lower than that of the bottom of the radial dynamic pressure grooves 82a and 82b. As a result, the likelihood of producing shavings is reduced.

It should be noted that the shaft 20 comes into contact with the circumferential contact parts 124 and 126 while rotating with respect to the circumferential contact parts 124 and 126. Therefore, the surface roughness of the circumferential contact parts 124 and 126 as measured in the circumferential direction may be smaller than the surface roughness as measured in the axial direction. This further reduces the likelihood of producing shavings.

Referring to FIG. 6A, the inner surface 80a of the sleeve 80 is formed with a first enlarged-diameter part 134 extending from the first circumferential contact part 124 toward the hub 10 and having a larger diameter than the first circumferential contact part 124, and a second enlarged-diameter part 136 extending from the second circumferential contact part 126 toward the base plate 50 and having a larger diameter than the second circumferential contact part 126. The first enlarged-diameter part 134 and the second enlarged-diameter part 136 are formed to maintain a non-contact state with respect to the shaft 20 while the device is not in rotation.

Since the lubricant 92 is churned in association with the rotation of the rotating device 100, particles from the shavings produced in the circumferential contact parts 124 and 126 are likely to be dispersed in the liquid phase of the lubricant 92. In other words, the shavings do not remain collected at one location but dispersed in the entirety of the lubricant 92. Accordingly, by maintaining much of the lubricant 92 in the enlarged-diameter parts 134 and 136, the shavings are moved to the gaps corresponding to the enlarged-diameter parts 134 and 136, reducing the relative amount of shavings moved to the dynamic pressure generation parts 120 and 122 and collected therein. As a result, the shavings are prevented from exercising adverse impact.

In order to further reduce the impact from shavings, the circumferential contact parts 124 and 126 are formed with a discharge groove 138 aligned with the direction of the motor rotational axis J. The shavings produced in the circumferential contact parts 124 and 126 are moved to the discharge groove 138 and moved from the discharge groove 138 to the gap corresponding to the enlarged-diameter parts 134 and 136. Therefore, the relative amount of shavings moved to the dynamic pressure generation parts 120 and 122 and collected therein is reduced.

The sleeve 80 may be formed with the radial dynamic pressure grooves 82 and 82b and with the discharge groove 138 in separate steps. However, such an approach will require additional steps to work the sleeve 80. To address this, the radial dynamic pressure grooves 82a and 82b may be formed so as to be continuous with the discharge groove 138. This is advantageous in reducing the steps to work the sleeve 80.

The radial dynamic pressure grooves 82a and 82b may be formed with a depth different from that of the discharge groove 138. However, this is difficult to achieve by ball rolling. To address this, the radial dynamic pressure grooves 82a and 82b and the discharge groove 138 may be formed with the same depth. This is advantageous in that the sleeve is worked by ball rolling, which is characterized by fewer steps for working.

A description will now be given of the operation of the rotating device 100 constructed as described above. A three-phase driving current is supplied to the rotating device 100 to rotate the hub 10 of the rotating device 100. Driving fluxes are generated along the nine teeth 64 by making the driving current flow through the coils 70. These driving fluxes give torque to the cylindrical magnet 40, and the hub 10 rotates.

According to the rotating device 100 of the embodiment, resonance in the translation mode caused by the torque ripple included in the torque generated by the driving mechanism is suppressed so that noise caused by the resonance is reduced. Rigidity in the radial direction is sacrificed to a certain degree for reduction of noise, but the embodiment provides the rotating device 100 more adapted to the situation addressed by the embodiment. In particular, damage to the radial dynamic pressure grooves caused by the tilting of the shaft 20 is reduced.

Described above is an explanation of the structure and operation of the rotating device 100 based on an exemplary embodiment. The embodiment is intended to be illustrative only and it will be obvious to those skilled in the art that various modifications to constituting elements and processes could be developed and that such modifications are also within the scope of the present invention.

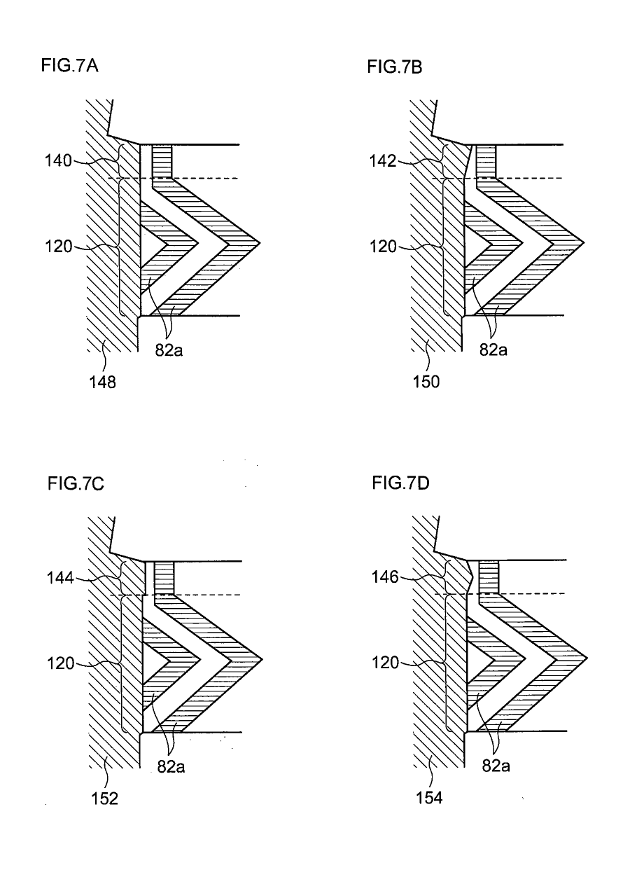

In the embodiment, the first circumferential contact part 124 is described as being formed in a tapered shape with a taper angle θt such that the radius is progressively larger toward the hub 10 from the end of the first dynamic pressure generation part 120 toward the hub 10, but the structure of the first circumferential contact part 124 is not limited to the one described. FIGS. 7A, 7B, 7C, and 7D show variations of the first circumferential contact part. FIGS. 7A, 7B, 7C, and 7D correspond to FIG. 6C.

FIG. 7A is an enlarged transparent section showing a sleeve 148 having a first circumferential contact part 140 according to a first variation. The first circumferential contact part 140 according to the first variation is formed in a cylindrical shape having the same diameter as the first dynamic pressure generation part 120.

FIG. 7B is an enlarged transparent section showing a sleeve 150 having a first circumferential contact part 142 according to a second variation. The first circumferential contact part 142 according to the second variation is formed in a tapered shape such that the radius is progressively smaller toward the hub 10 from the end of the first dynamic pressure generation part 120 toward the hub 10.

FIG. 7C is an enlarged transparent section showing a sleeve 152 having a first circumferential contact part 144 according to a third variation. The first circumferential contact part 144 according to the third variation is formed in a cylindrical shape having a smaller diameter than the first dynamic pressure generation part 120.

FIG. 7D is an enlarged transparent section showing a sleeve 154 having a first circumferential contact part 146 according to a fourth variation. The first circumferential contact part 146 according to the fourth variation is formed such that the radius is progressively smaller halfway toward the hub 10 from the end of the first dynamic pressure generation part 120 toward the hub 10 and grows larger beyond.

In any of the cases of FIGS. 7A, 7B, 7C, and 7D, the first circumferential contact part comes into contact with the shaft 20 prior to the dynamic pressure generation parts 120 and 122, when the shaft 20 is inclined with respect to the motor rotational axis J to come into contact with the inner surface of the sleeve. In the embodiment, the entirety of the first circumferential contact part 124 comes into contact with the shaft 20 when the shaft 20 is inclined with respect to the motor rotational axis J to come into contact with the inner surface 80a of the sleeve 80. In the case of the fourth variation shown in FIG. 7D, for example, the portion of the first circumferential contact part 146 with a progressively larger diameter beyond halfway toward the hub comes into contact with the shaft 20 when the shaft 20 is inclined with respect to the motor rotational axis J to come into contact with the inner surface of the sleeve 154.

A similar discussion holds true of the second circumferential contact part 126.

Alternatively, the first dynamic pressure generation part may be formed in a tapered shaped with a progressively smaller diameter toward the hub 10, and the first circumferential contact part may be formed in a cylindrical shape having the same diameter as the outer end of the tapered shape. Further, the first circumferential contact part in this case may be formed in a tapered shape with a diameter progressively larger toward the hub 10 from the end of the first dynamic pressure generation part 120 toward the hub 10.

In the embodiment, the outer surface 20a of the shaft 20 is described as being formed with a first opposite part 128 in a cylindrical shape facing the first circumferential contact part 124, a cylindrical opposite part 132 facing both the first dynamic pressure generation part 120 and the second dynamic pressure generation part 122, and a second opposite part 130 in a cylindrical shape facing the second circumferential contact part 126. However, the structure of the outer surface is not limited to the one described. For example, the portion of the outer surface of the shaft facing the circumferential contact part may have a shape conforming to the shape of the circumferential contact part. This can increase the area of contact between the shaft and the circumferential contact part occurring when the shaft is inclined and so decrease the surface pressure there.

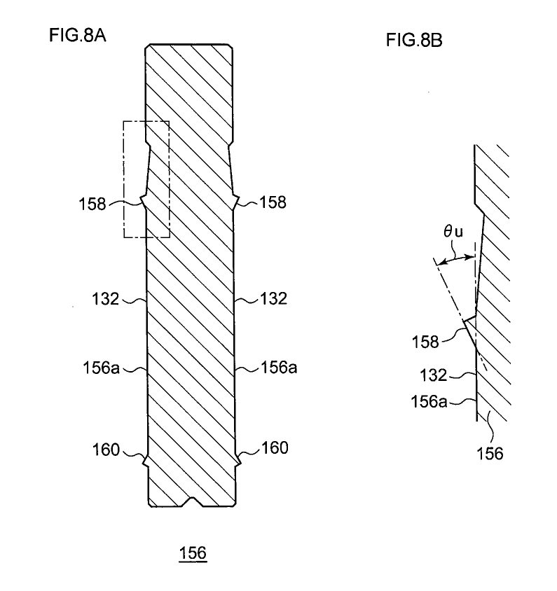

FIGS. 8A and 8B illustrate a shaft 156 according to a fifth variation. FIG. 8A is a section of the shaft 156 according to the fifth variation. FIG. 8B is an enlarged view of an area encircled by the dashed line of FIG. 8A.

An outer surface 156a of the shaft 156 according to the fifth variation is formed with a third opposite part 158 facing the first circumferential contact part 124, a cylindrical opposite part 132 facing both the first dynamic pressure generation part 120 and the second dynamic pressure generation part 122, and a fourth opposite part 160 facing the second circumferential contact part 126. The third opposite part 158 is formed in a tapered shape with a diameter progressively larger toward the hub 10 in accordance with the tapered shape of the first circumferential contact part 124. The fourth opposite part 160 is formed in a tapered shape with a diameter progressively larger toward the base plate 50 in accordance with the tapered shape of the second circumferential contact part 126. The maximum value of the diameter of the third opposite part 158 and the maximum value of the diameter of the fourth opposite part 160 are larger than the diameter of the cylindrical opposite part 132 by 2 μm.

When the shaft is inclined due to, for example, a gyro moment, the third opposite part 158, or the fourth opposite part 160, or both, of the shaft 156 comes into contact with the corresponding circumferential contact part so that the shaft 156 and the dynamic pressure generation part can maintain a non-contact state. FIGS. 8A and 8B show the difference in the diameter larger than it actually is for ease of understanding.

The third opposite part 158 may be formed such that the tape angle θu satisfies the following expression.

$$0 < {θ}_{u} \leq arctan ( \frac{2 r}{L} )$$

In the embodiment, it is assumed that the thickness of the magnetic recording disk 200 mounted on the hub 10 is 1.27 mm, but the thickness is non-limiting. For example, the thickness of the magnetic recording disk may be 1.4 mm or more. This will be favorable in that the resonance frequency of the magnetic recording disk is changed so that vibration of the magnetic recording disk is suppressed. Alternatively, the thickness of the magnetic recording disk may be 1.7 mm or more. In this case, vibration of the magnetic recording disk is further reduced.

In the embodiment, the number of magnetic poles in the cylindrical magnet 40 is assumed to be eight and the laminated core 60 is assumed to have nine teeth. However, the numbers are not limited to the ones described. For example, the number of magnetic poles in the cylindrical magnet may be an even number between 8 and 16. The number of teeth in the laminated core 60 may be a multiple of 3 in a range between 9 and 18. In this case, the number of turns of coil can be increased even if the device is reduced in size, with the result that a large gap can be secured between the cylindrical magnet and the teeth. As a result, cogging torque is prevented from increasing so that vibration occurring when the device is driven can be reduced.

In the embodiment, the rotating device is described as being formed as one piece such that the base plate 50 rotatably supports the hub 10, but the configuration is non-limiting. For example, a brushless motor configured similarly as shown in FIG. 2 may be manufactured so that the resultant brushless motor may be fitted to the chassis of a hard disk drive.

A so-called outer-rotor type of rotating device in which the cylindrical magnet 40 is located outside the laminated core 60 is described in the embodiment. However, the present invention is not limited to this. For example, the present invention may be applied to a so-called inner-rotor type of rotating device in which the magnet is located inside the laminated core.

In the embodiment, the sleeve 80 is described as being fixed to the base plate 50, and the shaft 20 rotating with respect to the sleeve 80. Alternatively, the present invention may be applied to a shaft-fixed type of rotating device in which the shaft is fixed to the base plate, and the sleeve and the hub rotate together with respect to the shaft.

The embodiment is described as being mainly used in hard disk drives. However, the present invention is not limited to this. For example, one may manufacture a brushless motor having a structure shown in FIG. 2 and install the brushless motor into an optical disc writing/recording device such as a CD (Compact Disc) device or a DVD (Digital Versatile Disc) device.

While the preferred embodiments of the present invention have been described using specific terms, such description is for illustrative purposes only, and it is to be understood that changes and variations may be made without departing from the spirit or scope of the appended claims.

What is claimed is:

1. A rotating device comprising:
a rotor on which a recording disk is to be mounted;
a stator rotatably supporting the rotor; and
a driving mechanism configured to rotate the rotor with respect to the stator,
wherein the relationship between (a) the magnitude of a gap between the rotor and the stator and (b) a viscosity of a lubricant introduced in the gap is defined such that a Q-value of a peak of mechanical resonance in a translation mode of the rotating device is 3 or less when the peak of mechanical resonance and a peak of the torque ripple in the driving mechanism are in the ranges of 1 kHz-5 kHz in a frequency spectrum.

2. The rotating device according to claim 1,
wherein the relationship is given by
R≧k(η)^{0.34}
where R μm denotes the magnitude of the gap, η P denotes an absolute viscosity of the lubricant at 40° C., and k denotes a variable that depends on the Q-value and that does not depend on the magnitude R of the gap or the absolute viscosity of the lubricant, and where k is defined such that the larger the Q-value, the smaller the variable k.

3. The rotating device according to claim 1,
wherein the gap is formed such that the magnitude thereof is in a range between 5 μm and 7 μm.

4. The rotating device according to claim 1,
wherein the stator has a cylindrical sleeve around a rotational axis of the rotor,
the rotor is formed with a shaft accommodated in the sleeve,
a surface of the sleeve facing the shaft is formed with a dynamic pressure generation part provided with a radial dynamic pressure groove, and is formed with a circumferential contact part provided to extend from the dynamic pressure generation part, and
the circumferential contact part comes into contact with the shaft prior to the dynamic pressure generation part, when the shaft is inclined with respect to the rotational axis to come into contact with the surface of the sleeve facing the shaft.

5. The rotating device according to claim 4,
the circumferential contact part is formed such that a diameter of a portion of the circumferential contact part that comes into contact with the shaft when the shaft is inclined with respect to the rotational axis to come into contact with the surface of the sleeve facing the shaft becomes progressively larger as it goes away from the dynamic pressure generation part in a direction of the rotational axis.

6. The rotating device according to claim 4,
wherein a surface of the shaft facing the sleeve is formed such that a portion of the surface facing the circumferential contact part is larger than the diameter of a portion of the surface facing the dynamic pressure generation part.

7. The rotating device according to claim 4,
wherein a portion of the shaft facing the sleeve and facing, in particular, the circumferential contact part has a shape conforming to a shape of the circumferential contact part.

8. The rotating device according to claim 4,
wherein the circumferential contact part is formed such that the width thereof in a direction of the rotational axis is in a range between 1/10 and ⅓ the width of the dynamic pressure generation part in the direction of the rotational axis.

9. The rotating device according to claim 4,
wherein the circumferential contact part is formed such that the width thereof in a direction of the rotational axis is in a range between 0.5 mm and 2 mm.

10. The rotating device according to claim 4,
wherein the surface of the sleeve facing the shaft is formed with an enlarged-diameter part provided to extend from the circumferential contact part in a direction opposite to the dynamic pressure generation part and have a larger diameter than the circumferential contact part.

11. A rotating device comprising:
a rotor on which a recording disk is to be mounted;
a stator rotatably supporting the rotor; and
a driving mechanism configured to rotate the rotor with respect to the stator,
wherein a peak of mechanical resonance in a translation mode of the rotating device and a peak of torque ripple in the driving mechanism are in the ranges of 1 kHz-5 kHz in a frequency spectrum,
the stator has a cylindrical sleeve around a rotational axis of the rotor,
the rotor is formed with a shaft accommodated in the sleeve,
a surface of the sleeve facing the shaft is formed with a dynamic pressure generation part provided with a radial dynamic pressure groove, and is formed with a circumferential contact part provided to extend from the dynamic pressure generation part, and
the circumferential contact part comes into contact with the shaft prior to the dynamic pressure generation part, when the shaft is inclined with respect to the rotational axis to come into contact with the surface of the sleeve facing the shaft.

12. The rotating device according to claim 11,
wherein the circumferential contact part is formed such that a diameter of a portion of the circumferential contact part that comes into contact with the shaft when the shaft is inclined with respect to the rotational axis to come into contact with the surface of the sleeve facing the shaft becomes progressively larger as it goes away from the dynamic pressure generation part in a direction of the rotational axis.

13. The rotating device according to claim 11,
wherein a surface of the shaft facing the sleeve is formed such that a portion of the surface facing the circumferential contact part is larger than the diameter of a portion of the surface facing the dynamic pressure generation part.

14. The rotating device according to claim 11,
wherein a portion of the shaft facing the sleeve and facing, in particular, the circumferential contact part has a shape conforming to a shape of the circumferential contact part.

15. The rotating device according to claim 11,
wherein the surface of the sleeve facing the shaft is formed with an enlarged-diameter part provided to extend from the circumferential contact part in a direction opposite to the dynamic pressure generation part and have a larger diameter than the circumferential contact part.

16. The rotating device according to claim 11,
wherein the surface of the sleeve facing the shaft is formed with another circumferential contact part provided to extend from the dynamic pressure generation part in a direction opposite to said circumferential contact part, and
one of the circumferential contact part and the other circumferential contact part comes into contact with the shaft prior to the dynamic pressure generation part, when the shaft is inclined with respect to the rotational axis to come into contact with the surface of the sleeve facing the shaft.

17. The rotating device according to claim 11,
the circumferential contact part is formed such that a surface roughness thereof is smaller than that of a bottom of the radial dynamic pressure groove.

18. The rotating device according to claim 11,
wherein the circumferential contact part is formed with a discharge groove aligned with a direction of the rotational axis.

19. The rotating device according to claim 18,
wherein the discharge groove is formed to be continuous with the radial dynamic pressure groove.

20. The rotating device according to claim 18,
wherein the discharge groove is formed with the same depth as the radial dynamic pressure groove.
